(19) United States
(12) Patent Application Publication
(10) Pub. No.: US 2014/0193008 A1
(43) Pub. Date: Jul. 10, 2014

(54) SYSTEM AND METHOD FOR FITTING OF A HEARING DEVICE

(71) Applicant: Tarik Zukic, Bruckengasse (AT)

(72) Inventor: Tarik Zukic, Bruckengasse (AT)

(73) Assignee: TWO PI SIGNAL PROCESSING APPLICATION GMBH, Wien (AT)

(21) Appl. No.: 14/240,461

(22) PCT Filed: Aug. 24, 2012
(86) PCT No.: PCT/AT2012/050119

§ 371 Date: Feb. 24, 2014

(30) Foreign Application Priority Data
Aug. 30, 2011 (EP) 11179340.2

(51) Int. Cl. H04R 25/00

(52) U.S. Cl. CPC H04R 25/50
USPC 381/314

(57) ABSTRACT

The invention relates to system and method for configuring a hearing device (100) with an external configuration unit (101), the method comprising the steps of: a) processing at least two sound recordings in the external processing unit (104′) with different parameter settings (105′a, 105′b), b) combining them into one joint signal, c) feeding the joint signal to the hearing device's output transducer (107), bypassing the rest of the hearing device (100), d) emitting the joint signal, e) letting the user (111) choose one of the sound recordings that fits his/her requirements best, f) repeating steps a) to e) with varying parameter settings, g) transmitting a chosen parameter setting to the hearing device (100), wherein in step a) the sound recordings to be processed are chosen according to the situation the hearing device (100) will be used for or the specific hearing impairment of a user (111) of the hearing device (100).

The invention relates to a method for configuring a hearing device, said hearing device comprising at least one input transducer, at least one A/D-converter, at least one processing unit with a memory, at least one D/A-converter, and at least one output transducer, said external configuration unit comprising at least one programming host, at least one external processing unit, at least one programming interface, and a playing device to play sound recordings and/or visual information. The invention further relates to a system for performing said method.

Here and in the following description the term A/D-converter stands for an analogue-digital converter that converts continuous signals into digital information in discrete form. The reverse operation is performed by a D/A-converter, a digital-analogue converter.

Hearing devices usually comprise an input transducer like a microphone to pick up incoming sound waves, an output transducer like a receiver or loudspeaker and a signal processing unit in between that can be individually adapted to different requirements depending on the environment or the disabilities of the user of the hearing device. Hearing devices might be hearing aids as used by hearing-impaired people but also communication devices or hearing protection devices as used by individuals working in noisy surroundings.

The adjustment of the hearing device to a user's preference and requirements related to the existing hearing loss as well as to different environments is a cumbersome procedure, usually requiring the help of an acoustician or audiologist. The reason for this is the range and complexity of parameters of hearing devices, which can be controlled only by appropriately trained specialist personnel.

Fitting of a hearing device relates to the adjustment of internal signal processing parameters of the hearing device to compensate for hearing loss or hearing difficulties. Adaptation or fitting of a hearing device by configuration of the signal processing unit is done by changing different internal processing parameters, like gain, dynamic compression ratio, noise reduction strength and the like, until the parameter set best suited for the user is determined. Hence, the adaptation or fitting procedure of a hearing device consists of individual evaluation of different parameter sets and a choice of the best set, in most cases by a user with the help of qualified personnel.

According to prior art, hearing devices are usually configured using audiometric data such as audiograms. Audiograms are obtained using dedicated devices like audiometers and some procedures for hearing loss assessment (pure-tone audiogram, speech-in-noise test etc.). The audiograms are a basis for calculation of signal processing parameters—usually amplification parameters such as gain and compression ratio.

The usual configuration of hearing devices consist of determining amplification parameters that best compensate hearing disabilities. The first step is to estimate individual hearing disability levels of the user using audiometric means—usually conducted by qualified personnel.

This process results in an audiogram presenting hearing loss level at different frequencies. Audiogram data is then imported into a host computer such as a PC with a fitting software that applies a prescriptive formula to the audiogram data to calculate optimal amplification parameters. Nowadays, the most common prescriptive formulae are NAL-NL 1 or NAL-NL 2 from the Australian national acoustical lab and DSL i/o from the Canadian National Centre for Audiology. Those formulas can be licensed for use in devices or in software. Usually they are employed in form of libraries that are embedded into fitting software. The libraries can compute the processing parameters (gains, compression ratio) according to individual audiograms.

The amplification parameters are then transmitted to a hearing device from the host computer—this personalizes the hearing device to the specific needs of a user.

The user can then test the device by listening to different environmental sounds. Different pre-recorded sounds are used to evaluate the effects of signal processing. The sounds, played from an audio device, e.g. a stereo, a CD-player or a PC, are picked up by the microphone of the hearing device, processed using the signal processing unit with the latest parameter setting and provided to the ear of the individual via the output transducer.

In a variant of common fitting procedures, an interface like “NoahLink” or other frequency modulating transmission devices or Bluetooth®-streaming devices might be used to feed reference sounds directly into the device. In this case the microphone of the hearing device is bypassed, thus also neutralizing the negative influence of disturbing sounds of the surrounding area.

If the performance of the hearing device is not satisfactory the parameters can be fine-tuned by qualified personnel in a process called “paired comparisons”: The user listens while the professional changes the internal parameter settings of the hearing device; after each change the user evaluates the new parameter setting. The evaluation is usually done by comparison of a signal with the latest processing parameters with a signal processed with a previous set of parameters. The evaluating person makes a choice by his/her auditory preference. The outcome of the fitting procedure is influenced by the ability of the user of the hearing device to remember the sound preference before the latest parameter change. This ability usually decreases over time, particularly, when the fitting procedure lasts very long. Finally, the user gives his preference to one of the parameter settings.

At the end of the procedure the chosen parameter setting is permanently stored to the non-volatile memory of the hearing device.

A method for configuring or fitting a hearing device is described in the applicant's EP 2 175 669.

The invention sets out to overcome the above-mentioned shortcomings of the prior art by providing an easy to implement and straightforward way of configuring the parameter setting of a hearing device to the needs of a user.

This task is solved by a method according to the invention, said method comprising the following steps:
a) processing at least two sound recordings from the playing device in the external processing unit of the external configuration unit at the same time, wherein each sound recording is processed with a different parameter setting,
b) combining the sound recordings that are processed with different parameter settings into one joint signal,
c) feeding the joint signal to the output transducer of the hearing device via the interface and the D/A-converter, bypassing the input transducer, the A/D-converter and the processing unit of the hearing device,
d) emitting the joint signal through the output transducer of the hearing device,
e) letting the user of the hearing device decide for one of the sound recordings of the joint signal that fits his/her requirements best,
f) repeating steps a) to e) with varying parameter settings, each time retaining the parameter setting of the sound recording chosen by the user in step e) for one of the sound recordings in step a),
g) transmitting the chosen parameter setting to the hearing device and storing it in the memory of the hearing device once a match between the quality of the signal and the requirements of the user of the hearing device is reached,
   wherein in step a) the sound recordings to be processed are chosen according to the situation the hearing device will be used for or the specific hearing impairment of a user of the hearing device.

By virtue of this solution it is possible to replace the common two-step procedure that requires an audiogram as a basis for the calculation of signal processing parameters with a method for direct search of signal processing parameters. The search is based on an interactive procedure of simultaneously presenting two or more acoustic stimuli to a user and the user's feedback according to his specific needs.

The user himself/herself can complete the configuration/fitting of the hearing device thus making hearing devices more accessible. In particular, the method allows for automatic adjustment of the internal amplification parameters of the hearing device.

In particular the at least one interface may advantageously be suited for exchange of control data and audio data. The playing device may advantageously be an audio-visual utility to play sound recordings and/or visual information.

Preferably, in step c) the interface uses a wireless connection or telephone network between the external configuration unit and the hearing device. This allows for a better usability of the system. In addition this allows that the user can be at the same or at a different place than the external configuration unit.

In particular the system may advantageously be supported by an app-software running on an external configuration unit (such as smart phone or tablet device). Preferably, the app software in the external configuration unit uses a wireless connection or telephone network to communicate with a centralized server to access a variety of audio-visual data used in the fitting process and to store and retrieve the user and device data.

In step f) the variation of the parameter settings is done by using an appropriate algorithm like steepest descent search or genetic algorithm or, more generally, an evolutionary algorithm.

“Steepest descent search” here means that the new parameter settings are based on the preference feedback in such a way that they are closer to the retained parameter setting than to the rejected parameter setting. The procedure is repeated until the preference feedback indicates that the new parameter settings are not better than the previous ones—in which case the optimum is reached.

“Evolutionary algorithm”, in particular “genetic algorithm”, here stands for an approach where the new parameter settings are a result of crossover and mutation of already evaluated parameter settings based on their “fitness”. The evaluation of the parameter settings (calculation of their “fitness”) is based on the user response in step e).

Next to abovementioned algorithms, other appropriate algorithms may be used, e.g. by using the well known methods of paired comparisons. Also, combinations of known algorithms may be used.

The external configuration unit comprises at least one screen and in step d) the emitting of the processed sound recording is accompanied by the playback of visual signals on the screen, visible to the user of the hearing device. Preferably, the screen is a touch screen. This allows for a more direct involvement of the user in the configuration process. In step d) each sound recording is represented by an object pictured on the screen. The object may advantageously be a human subject (speaker).

The object may be a person, an instrument or any other entity capable of emitting sound or related to the emission of sound by the user. In case a dialogue between two persons is played to the user, a video output would display two people talking to each other.

This improves the situation for the user, giving him/her the opportunity to focus on the quality of the sound recordings he/she is listening to. In order to prevent the results of the configuration process to be spoiled by any sympathies of the user towards any of the conversation partners (in case a dialogue is shown) it is also possible to show an animated film with neutral-looking or even identical (e.g., animated) figures.

The choice of the user in step e) is collected in at least one of the following ways:
e1) discrete rating relating to the objects representing the sound recordings,
e2) quantitative rating relating to the objects representing the sound recordings,
e3) quality rating corresponding to the understandability of the sound recordings and/or the objects they are represented by,
e4) comparative rating of the objects representing the sound recordings.

“Discrete rating” here means that the user decides for one of the processed recordings that is played to him/her in the joint signal. In case the joint signal is a conversation between two speakers A and B, the user decides whether speaker A is preferable to speaker B or vice versa.

“Quantitative rating” enhances the discrete approach by gradating the decision of the user—the understanding of a speaker may be good, very good, etc., wherein the other speaker(s) may be understandable in different levels of bad to worse to very bad, etc.

The “quality rating” relates to the recognition of the things uttered by the two sound recordings. The user chooses a word or phonetic entity corresponding to what he/she has understood.

The “comparative rating” relates the first signal to other signals, e.g., speaker A is much better/same/worse than speaker B.

In step a) the recording signals are processed in such a way that a sound pressure level (SPL) at the eardrum of a user after processing corresponds to the sound pressure level (SPL) at the eardrum of the user when listening to real signals, preferably by applying to the recording signals at least one of the following transfer functions: recording equipment, influence of the earlobe, influence of the input- and/or output-transducer of the hearing device.

In step f), when alternating the parameter settings for processing the recording signals, significantly audible SPL-differences of at least predetermined level ratio such as 5 dB or 10 dB are provided within a frequency range of the signal at the beginning of the search with the SPL-differences decreasing with increasing number of iterations, such as down to 2 dB or 5 dB.

This means that at first, large step-sizes are applied, with the step-sizes decreasing to finer steps with increasing number of iterations.

In step a) before processing the parameter settings used are obtained by selecting at least two audiograms from the whole audiogram search space and calculating the parameter settings from the audiogram data.

This allows searching for parameter settings without the need to measure an audiogram. With no underlying audiogram data for calculation of amplification parameters, the search for parameter settings can be made by comparing the preference for different audiograms. This significantly reduces a number of search parameters: an audiogram has only one value for each given frequency; amplification has at least four significant values (gain, compression ratio and compression and saturation threshold).

When selecting the audiograms, hypothetical audiograms are selected that are not based on any interactions with the user. The process of the selection can be chosen freely and depends on the search algorithm used and other presumptions. A possible approach would be to account for the fact that a significant percentage of all hearing impairments is of high frequency nature. This fact can be used for educated guessing of an audiogram. The initial audiograms choice can be more precise when inputs from the user are collected first: questionary about age, encountered hearing difficulties, experience with hearing devices etc.

Preferably, the calculation of the parameter settings from the audiogram data is done by using at least one of the following formulae: NAL-NL1, NAL-NL2 or DSL i/o.

NAL-NL (National Acoustics laboratories “non-linear fitting Version 1”) is a hearing aid fitting software and a related method, comprising the entering of audiogram data, specification of parameters and extraction of prescriptions for how to configure a hearing aid.

Like NAL-NL, DSL i/o is a prescriptive procedure that incorporates real-ear measurements for prescribing amplification; with different formulae, gain is related to hearing thresholds. DSL i/o is a development of the National Centre for Audiology of the University of Western Ontario.

However, other methods for the calculation of the parameter settings from the audiogram data may be used as well.

In step f), when repeating the search sequence, the audiograms used for calculating the parameter settings are alternated frequency by frequency.

Abovementioned task is further solved by a system according to the invention, the system comprising means to perform abovementioned method. In a variant of the invention, the external configuration unit of the system comprises at least one screen, preferably a touch screen.

In the following, the present invention is described in more detail with reference to the drawings, which show:

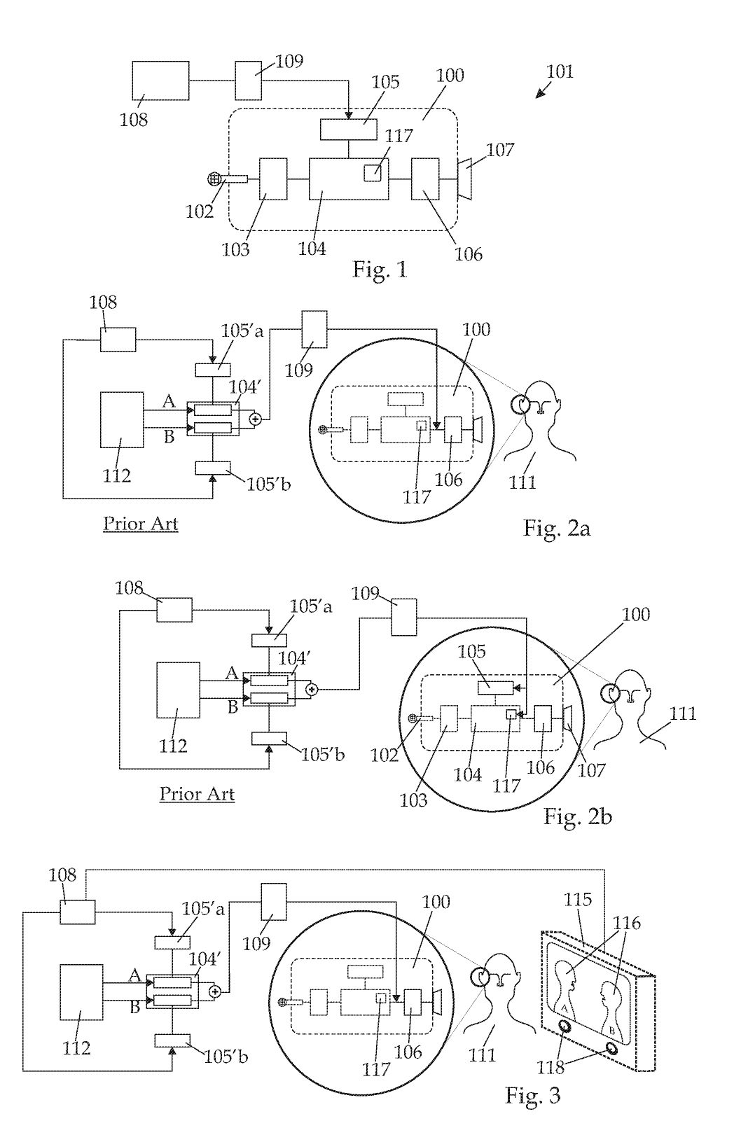

FIG. 1 a schematic view of the main components of a hearing device applying the method according to the invention,

FIG. 2a a first step of a prior art method for configuring a digital hearing device according to the invention,

FIG. 2b a second step of the prior art method of FIG. 2a, and

FIG. 3 a variant of the method according to the invention.

It should be appreciated that the invention is not restricted to the following embodiments which merely represent one of the possible implementations of the invention. Furthermore, it is noted that the representations in the figures are only schematic for the sake of simplicity.

Throughout the figures, same objects are denoted with the same reference signs. In the following, the sounds coming to the eardrum of a user are referred to as “stimuli” and the user's perception of them is referred to as “sensation”.

FIG. 1 shows a schematic view of a digital hearing device 100. The method according to the invention is applied to such a hearing device 100, using an external configuration unit 101. The external configuration unit 101 is not part of the hearing device 100 but used for the configuration and fitting procedure.

The hearing device 100 comprises an input transducer 102 (e.g., a microphone or an inductive coil) to pick up incoming sound waves. The signals of the input transducer 102 are then transformed by an A/D-converter 103, creating a digital signal from the analogue input. The digital signal is fed into a processing unit 104 (e.g., a digital signal processor) and processed—the processing can either be implemented as a software for a processor on a digital device or hard-wired as an integrated circuit. Signal processing always applies a certain amount of gain.

The processing unit 104 applies routines on the signal to vary a number of its parameters. The current parameter setting 105 is usually stored in a RAM memory of the processor, preferably a non-volatile memory 117 like an EEPROM (Electrically Erasable Programmable Read-Only Memory). However, for configuration- or fitting purposes the parameter settings 105 may also be adjusted externally. Examples for the varying parameters of the signal are gain, dynamic compression ratio, dynamic compression thresholds, noise reduction strength and the like. A parameter setting 105 is a set of values of each of the parameters.

After the processing, the signal is fed through a D/A-converter 106 to obtain an analogue signal. The analogue signal is then output through an output transducer 107, e.g. a speaker or a vibrating device, to the ear of the user of the hearing device 100.

For fitting the hearing device 100 to the needs of the user, an external configuration unit 101 is used. This unit 101 basically comprises a programming host 108 and a programming interface 109. The programming host 108 may be a PC, a hand-held device or the like. Furthermore, a device to play recorded sound signals (in a variant of the invention in combination with visual information) and some other equipment may be used in the fitting procedure—however, such equipment is not shown in FIG. 1 for the sake of simplicity.

The programming interface 109 serves to transmit the commands of the programming host 108 to the hearing device 100. It can also comprise the features of an audio-streaming device, transmitting sound recordings from the external configuration unit 101 to the hearing device 100. The transmission could be effected either by use of cables and serial connections or wirelessly, depending on the type of interface 109. Thus, the interface 109 may have transmission and receiving means, e.g. in the form of antennae, to connect via a wireless network or an appropriate computer network. FIG. 1 shows only a schematic view of an interface, not being specific about the nature of the transmission, hence not excluding any of the above mentioned possibilities.

The programming interface 109 may be an interface like HiPro, NoahLink and the like. The latter two are well established standards in the field of hearing devices and used to configure and/or program such devices.

NoahLink utilizes the high-speed wireless technology Bluetooth. However, other forms of interfaces may be used as well; in principle, a simple cable, allowing feeding of programming and/or audio information to the hearing device 100, might suffice. Another, much more elaborate variant would be a telephone or wireless network, connecting the hearing device 100 with the external configuration unit 101.

The incorporated signal processing of hearing devices 100 has to be adapted (fitted) to the individual hearing deficiencies of a user or the acoustic environment where the device will be used, in most cases by configuration of the parameters (e.g., the parameter setting 105). In the broadest sense, the individual adaptation involves the process where a user repeatedly compares two (or more) signal processing settings (i.e., signals, processed by application of two different parameter settings) and chooses the one that results in the better quality of the signal.

According to prior art there are different methods of fitting a hearing device 100. In a first variant, sound recordings are played to a user and the parameter setting 105 of the processing unit 104 of the user's hearing device 100 is specified by the external configuration unit 101. Once a suitable parameter set 105 is determined it is stored in a non-volatile memory 118 of the hearing device 100. This method needs to be performed in a fitting room at a physician's or an audiologist's.

In another method, sound recordings are fed directly into the hearing device 100 via the programming and streaming interface 109. Hence, no fitting room is needed and the requirements for properly applying the method are eased (no special premises are necessary; influence of environmental noise is diminished, . . . ).

The directly fed signal is adjusted in level and frequency to correspond to the environmental sound signal that would be picked up by the microphone of the hearing device 100. This is possible since the sensitivity of the microphone is known.

From the external configuration unit 101 different parameter settings 105 are implemented in the processing unit 104 and, consequently, applied to the sound recordings. The user of the hearing device 100 evaluates each parameter setting 105 in comparison to the others. Once the best parameter setting 105 is determined it is stored permanently in a non-volatile memory 118 of the hearing device 100.

In yet another method according to prior art as disclosed in the applicant's EP 0 175 669 (see FIGS. 2a and 2b) not only the specification of the parameter setting 105 but also the processing is done externally. Therefore, the relevant signal processing is not done in the hearing device 100 but is performed in the external configuration unit 101. Furthermore, signals with different parameter settings are not played consecutively, but at the same time, therefore facilitating the choice of the best parameter setting.

The external configuration unit 101 comprises a programming host 108, an external processing unit 104′ (applying a parameter setting 105′), a player 112 to play sound recordings and a programming interface 109.

The present invention relates to improvements of the method as disclosed in EP 0 175 669.

In the first step of the method, depicted in FIG. 2a, sound recordings (either digital or analogue) from a player 112 are fed into an external processing unit 104′. Since the sound recordings are processed outside of the hearing device 100 and the internal parameter set 105 of the hearing device 100 does not have to be changed it is possible to play sound recordings that are processed with different parameter sets in parallel. This means that sound recordings are processed outside of the hearing device 100, mixed into one joint signal and then transmitted to the output transducer 107 of the hearing device 100. In the embodiment in FIG. 2a, two sound recordings “A” and “B” are used. However, it is possible to use more recordings as well.

The sound recordings are pre-recorded, stored and reproduced by the player 112, which can be a PC, tablet PC, handheld computer, hi-fi system or similar device.

The programming host 108 of the external configuration unit 101 configures parameter settings 105′a, 105′b that are used in the external processing unit 104′ to process the sound recordings. The processed sound recordings are then mixed into one joint signal. The two sound recordings, however, are still distinguishable. For instance, sound recording “A” is a first person speaking while sound recording “B” is a second person speaking and the mixture of the two sound recordings sounds like a conversation of two speakers.

Via the interface 109 the joint signal is then fed into the hearing device 100, i.e. to the output transducer 107 of the hearing device 100 via the interface 109 and the D/A-converter 106. This means that the processed signal is fed into the hearing device 100 before the D/A-converter 106, or after the internal processing unit 104, respectively.

The output transducer 107 then outputs the processed signal. The other components of the hearing device 100, i.e. input transducer 102, A/D-converter 103 and processing unit 104, are bypassed. This fact is illustrated by picturing said components in FIGS. 2a and 2b in the form of dotted lines.

The user 111 listens to the joint signal of differently processed sound recordings and chooses which one is better audible to him/her. With this decision he/she demonstrates his/her preference for one parameter setting. The decision is input into the programming host 108 for the processing of a new (or the same) set of sound recordings with new (or amended) parameter settings 105′a, 105′b.

Instead of comparing a sound recording with a parameter set B with the memory of a sound recording with a parameter set A the user 111 listens to sound recordings with parameters A and B alternately and simply decides which of them suits his/her needs better.

The user's 111 feedback according to his/her sensation preference can be given in different ways:
discrete rating relating to only one of the sound recordings “A” or “B” (e.g.: “A is better than B”);
quantitative rating relating to one of the sound recordings “A” or “B” (e.g.: “A is very good, B is poorly understandable”, and the like);
quality rating corresponding to the understandability of “A” or “B” (e.g., when “A” and “B” are speakers in a conversation, here the understandability of the words uttered by “A” and “B” are evaluated; for instance, the user 111 can choose from a list of words which word was actually articulated by “A” or “B”);
comparative rating of “A” and “B” (“A” is much better/same/worse than “B”).

The results of each of the feedback is accounted for in the next round of parameter-calculation and sound-recording-processing.

In principle, it is also possible to input an analogue audio signal which is then processed by the external configuration unit 101 and fed into the A/D-converter 103 of the hearing device 100. In this case the internal processing unit 104 of the hearing device 100 has to be bypassed.

Once a suitable parameter setting 105′ is determined, step two of the method (FIG. 2b) is initiated. The determined parameter setting 105′ is transferred to the hearing device 100 and copied into the non-volatile memory 117 of the hearing device 100 or its processing unit 104, respectively.

It has to be noted that this is the only time in the whole process where any modifications are carried out in the hearing device 100.

Apart from that, all modifications are effected outside of the hearing device 100 and only the processed sound recordings are fed in the D/A-converter 105 of the hearing device 100. The events of step two are signified by the arrows in FIG. 2b: The determined parameter setting 105′ becomes the parameter setting 105 in the hearing device and is stored in the non-volatile memory 117 of the device.

In principle, it is also possible to store all possible parameter settings 105 in a table in the memory 118 of the hearing device 100. Once step two of the method is completed, not all the values of the parameters, but merely the information, which entry of the table has to be applied, is transmitted to the hearing device via the interface 109. The outcome, however, is the same: a configured hearing device 100 with a parameter setting 105, stored in the memory 117.

FIG. 3 shows an elaborate application of the method according to EP 0 175 669. Again a player 112 provides two sound bits “A” and “B”. The sound bits “A”, “B” might stem from the same recording or from different recordings. “A” might be the recording of one speaker, whereas “B” could be the recording of a second speaker; “A” might be a first instrument, “B” might be a second instrument, and the like. Alternatively, “A” and “B” might stem from a recording of one speaker, for instance. The pre-recorded sound bits might also represent a recording of two or more different sound sources. The sources can be human speakers in conversation or a restaurant situation, but may also be instruments playing, traffic noise and the like.

After the processing the sound bits “A”, “B” are mixed, transmitted to the hearing device 100 as a digital signal and fed into the hearing device 100 before the D/A-converter 106 by means of the interface 109 which again serves as an audio-streaming interface as well as an programming interface. The user 111 then decides which of the sound bits “A”, “B” has a better quality: Rather than choosing between sound recordings before and after the change of the parameter sets, the user 111 can choose between two or more distinguishable sound bits at the same time, all of which are processed with different signal processing settings (i.e. parameter settings).

In the embodiment of FIG. 3 the signal bits are supported by video footage. The example sound recordings may be combined with a video showing two objects, e.g., conversation of two (or more) partners, two (or more) music instruments and the like. In case a conversation of two partners is shown these partners might be human, however, it is also possible to generate animated figures to prevent sympathizing that might superimpose the objective perception. This variant of EP 0 175 669 is schematically depicted in FIG. 3.

The dashed structures comprise a screen 115, showing two figures 116. The screen 115 could be a conventional TV-screen, a TFT-, LCD- or cathode ray tube-display, but also the screen of a mobile device like a laptop, mobile phone, tablet PC or portable player of various kinds. Preferably the screen is a touch screen to enable user's feedback through touching the screen. This provides the user with a feeling of being involved in the conversation by excluding other means for giving feedback like computer mouse or keyboard.

The method according to the invention is based on the following steps:
a) Processing of at least two sound recordings from the playing device 112 in the external processing unit 104′ of the external configuration unit (101) at the same time, wherein each sound recording is processed with a different parameter setting 105′a, 105′b,
b) combining the sound recordings that are processed with different parameter settings 105′a, 105′b into one joint signal,
c) feeding the joint signal to the output transducer 107 of the hearing device 100 via the interface 109 and the D/A-converter 106, bypassing the input transducer 102, the A/D-converter 103 and the processing unit 104 of the hearing device 100,
d) emitting the joint signal through the output transducer 107 of the hearing device 100,
e) letting the user 111 of the hearing device 100 decide for one of the sound recordings of the joint signal that fits his/her requirements best,
f) repeating steps a) to e) with varying parameter settings, each time retaining the parameter setting of the sound recording chosen by the user 111 in step e),
g) transmitting the chosen parameter setting to the hearing device 100 and storing it in the memory 117 of the hearing device 100 once a match between the quality of the signal and the requirements of the user 111 of the hearing device 100 is reached.

In particular, it is not necessary to provide input data for the method, e.g. an audiogram or the like. The sounds played to the user 111 (and, hence, the signals) are chosen to realistically cover all acoustic situations relevant to the fitting goal. If the fitting goal is the understanding of speech respective stimuli are chosen.

The nature of hearing loss (HL) is spectral—the HL levels differ from frequency to frequency. Therefore the speech stimuli are chosen to cover all relevant spectral content.

Fitting always has an underlying goal such as “maximizing speech understanding” or “optimizing listening comfort”. This means that the sound recordings to be processed are chosen according to the situation the hearing device 100 will be used for or the specific hearing impairment of a user 111 of the hearing device 100.

For example: In order to assess the hearing loss at 6 kHz a consonant “s” is frequently used in the stimuli since it is covering frequencies from 4 kHz to 8 kHz.

The variation of the stimuli in step f) is done by using an appropriate algorithm—e.g. the “steepest descent search” or “evolutionary algorithm”, in particular “genetic algorithm” may be used. Other algorithms or combinations of different algorithms are possible as well.

The choice of parameter settings 105′a, 105′b can be done in different ways:

In one variant of the invention, the sound recordings are calibrated or processed in a way that the sound pressure level (SPL) at the eardrum corresponds to an SPL when listening to real signals. This is achieved by applying to the signal transfer functions of: recording equipment, influence of the earlobe, input- and output transducer of the hearing device. The modification is calculated for a device model and a standardized ear simulator.

Preferably, significant SPL-differences (e.g., 10 dB steps in SPL) are provided at the beginning of the search to accelerate the procedure, wherein finer steps (e.g., 2 dB or 5 dB) are used after some iterations.

Individual anatomical deviations from the standard ear simulator can be obtained only using cumbersome real-ear measurements—by using abovementioned approach, such measurements need not be performed.

This method achieves “flat insertion gain”, a known concept in hearing-aid technology.

In another variant of the invention, the audiogram approach is used without the need to effectively produce an audiogram with the help of specialist personnel. Such an approach is advantageous because it significantly reduces a number of search parameters: the audiogram has only one value at a given frequency; amplification can have four significant values (gain, compression ratio, compression and saturation thresholds) and more.

In said variant, the search for the optimal parameter setting is performed in the following way:

First, hypothetical audiograms are chosen. This means that two or more audiograms from the whole audiogram search space are selected. The process of the selection depends on the used search algorithm and on other presumptions. An example: Since a significant percentage of hearing impairments (around 80 percent) is of high frequency nature, audiograms mirroring such a hearing loss may be used as a starting point for the parameter settings.

The search for the initial audiograms can be streamlined when inputs from the user 111 are collected first, e.g. by means of a questionnaire about age, encountered hearing difficulties, experience with hearing devices and the like.

Then, the amplification parameters (i.e., the parameter settings) are calculated, e.g. by using formulae that are well known in audio-technology. Examples are NAL-NL1, DSL i/o and the like.

The sound recordings are then processed with the parameter settings according to above-mentioned steps a) to e).

In step e) audiograms for consecutive test runs may be chosen in different ways. In one variant, alternation of the audiograms can be made frequency by frequency to let the user 111 focus his/her response.

In the following an example for a starting point for the method according to the invention is presented. Here, high frequency loss is assumed, resulting in two audiograms (standardized frequencies: 250 Hz, 500 Hz, 1 kHz, 2 kHz, 4 kHz, 6 kHz, 8 kHz) that differ only in the upper frequency range.

### Initial Setup:

| | | | | | | |
|---|---|---|---|---|---|---|
| Audiogram A: | 0 | 0 | 0 | 0 | 0 | 0; |
| Audiogram B: | 0 | 0 | 0 | 10 | 10 | 10. |

Step 1 (user preference from initial setup is B):

| | | | | | | |
|---|---|---|---|---|---|---|
| Audiogram A: | 0 | 0 | 0 | 0 | 10 | 10; |
| Audiogram B: | 0 | 0 | 0 | 10 | 10 | 10. |

Step 2 (user preference from step 1 is B):

| | | | | | | |
|---|---|---|---|---|---|---|
| Audiogram A: | 0 | 0 | 10 | 10 | 10 | 10; |
| Audiogram B: | 0 | 0 | 0 | 10 | 10 | 10. |

The novel method can also be used as a fine-tuning step in a fitting software application as commonly used for adjustment of hearing aids. In this configuration the method is an addition to conventional audiometry based fitting, facilitating the fitting for the non-professional user.

1. Method for configuring a hearing device by means of an external configuration unit, said hearing device comprising:
at least one input transducer,
at least one A/D-converter,
at least one processing unit with a memory,
at least one D/A-converter, and
at least one output transducer,
said external configuration unit comprising:
at least one programming host,
at least one external processing unit,
at least one programming interface, and
a playing device to play sound recordings,
the method comprising the steps of:
a) processing at least two sound recordings from the playing device in the external processing unit of the external configuration unit at the same time, wherein each sound recording is processed with a different parameter setting,
b) combining the sound recordings that are processed with different parameter settings into one joint signal,
c) feeding the joint signal to the output transducer of the hearing device via the interface and the D/A-converter, bypassing the input transducer, the A/D-converter e and the processing unit of the hearing device,
d) emitting the joint signal through the output transducer of the hearing device,
e) letting the user of the hearing device decide for one of the sound recordings of the joint signal that fits his/her requirements best,
f) repeating steps a) to e) with varying parameter settings, each time retaining the parameter setting of the sound recording chosen by the user in step e) for one of the sound recordings in step a),
g) transmitting the chosen parameter setting to the hearing device and storing it in the memory of the hearing device once a match between the quality of the signal and the requirements of the user of the hearing device is reached,
wherein in step a) the sound recordings to be processed are chosen according to the situation the hearing device will be used for or the specific hearing impairment of a user of the hearing device.

2. Method according to claim 1, wherein in step a) the recording signals are processed in such a way that a sound pressure level (SPL) at the eardrum of a user after processing corresponds to the sound pressure level (SPL) at the eardrum of the user when listening to real signals, preferably by applying to the recording signals at least one of the following transfer functions: recording equipment, influence of the earlobe, influence of the input and output-transducer of the hearing device.

3. Method according to claim 1, wherein in step f), when alternating the parameter settings for processing the recording signals, significantly audible SPL-differences of at least a predetermined level ratio such as 5 dB or 10 dB are provided within a frequency range of the signal at the beginning of the search with the SPL-differences decreasing with increasing number of iterations, such as down to 2 dB or 5 dB.

4. Method according to claim 1, wherein in step a) before processing the parameter settings used are obtained by selecting at least two audiograms from the whole audiogram search space and calculating the parameter settings from the audiogram data.

5. Method according to claim 4, wherein the calculation is done by using at least one of the following formulae: NAL-NL1, NAL-NL2, DSL i/o.

6. Method according to claim 4, wherein in step f), when repeating the search sequence, the audiograms used for calculating the parameter settings are alternated frequency by frequency.

7. Method according to claim 1, wherein in step c) the interface uses a wireless connection or telephone network between the external configuration unit and the hearing device.

8. Method according to claim 1, wherein in step f) the variation of the parameter settings is done by using an appropriate algorithm like steepest descent search or evolutionary algorithm, in particular genetic algorithm.

9. Method according to claim 1, wherein the external configuration unit comprises at least one screen and in step d) the emitting of the processed sound recording is accompanied by the playback of visual signals on the screen, visible to the user of the hearing device.

10. Method according to claim 9, wherein the screen is a touch screen.

11. Method according to claim 9, wherein in step d) each sound recording is represented by an object pictured on the screen.

12. Method according to claim 1, wherein the choice of the user in step e) is collected in at least one of the following ways:
e1) discrete rating relating to the objects representing the sound recordings,
e2) quantitative rating relating to the objects representing the sound recordings,
e3) quality rating corresponding to the understandability of the sound recordings and/or the objects they are represented by,
e4) comparative rating of the objects representing the sound recordings.

13. System comprising a hearing device and an external configuration unit, for configuring the hearing device by means of the external configuration unit, wherein said hearing device comprises:
at least one input transducer,
at least one A/D-converter,
at least one processing unit with a memory,
at least one D/A-converter, and
at least one output transducer,
said external configuration unit comprising:
at least one programming host,
at least one external processing unit,
at least one programming interface, and
a playing device to play sound recordings,
the system further comprising means to perform a method according to claim 1.

14. System according to claim 13, where the external configuration unit comprises at least one screen, preferably a touch screen.

15. Method according to claim 2, wherein in step f), when alternating the parameter settings for processing the recording signals, significantly audible SPL-differences of at least a predetermined level ratio such as 5 dB or 10 dB are provided within a frequency range of the signal at the beginning of the search with the SPL-differences decreasing with increasing number of iterations, such as down to 2 dB or 5 dB.

16. Method according to claim 2, wherein in step a) before processing the parameter settings used are obtained by selecting at least two audiograms from the whole audiogram search space and calculating the parameter settings from the audiogram data.

17. Method according to claim 5, wherein in step f), when repeating the search sequence, the audiograms used for calculating the parameter settings are alternated frequency by frequency.

18. Method according to claim 2, wherein in step c) the interface uses a wireless connection or telephone network between the external configuration unit and the hearing device.

19. Method according to claim 2, wherein in step f) the variation of the parameter settings is done by using an appropriate algorithm like steepest descent search or evolutionary algorithm, in particular genetic algorithm.

20. Method according to claim 2, wherein the external configuration unit comprises at least one screen and in step d) the emitting of the processed sound recording is accompanied by the playback of visual signals on the screen, visible to the user of the hearing device.
